(19) United States
(12) Patent Application Publication
(10) Pub. No.: US 2006/0052571 A1
(43) Pub. Date: Mar. 9, 2006

(54) Method for the production of radiation-curable urethane (meth) acrylates

(75) Inventors: Yvonne Heischkel, Mannheim (DE); Wolfgang Paulus, Ober-Olm (DE); Reinhold Schwalm, Wachenheim (DE); Peter Enenkel, Hebheim (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Akitiengesellschaft, Ludwigshafen (DE)

(21) Appl. No.: 10/539,830

(22) PCT Filed: Dec. 16, 2003
(86) PCT No.: PCT/EP03/14286

§ 371 Date: Jun. 17, 2005

(30) Foreign Application Priority Data
Dec. 18, 2002 (DE) 102 59 673

(51) Int. Cl. C08G 18/00

(52) U.S. Cl. 528/44

(57) ABSTRACT

A radiation-curable urethane(meth)acrylate, a process for preparing a radiation-curable urethane(meth)acrylate, and a coating composition comprising a radiation-curable urethane(meth)acrylate, in which the radiation-curable urethane(meth)acrylate is tough and resilient and useful in coating systems for a variety of substrates.

The invention relates to a process for preparing tough and resilient, radiation-curable urethane (meth)acrylates, to these urethane (meth)acrylates themselves, and to the use thereof.

Radiation-curable compounds are increasingly finding use as coating systems for a variety of substrates.

EP-A-54 105, DE-A 33 16 593, EP-A-279 303 and EP-A1 921 168 disclose processes in a 1st stage of which a (meth)acrylic ester is prepared from (meth)acrylic acid and hydroxy compounds and in a second stage excess (meth)acrylic acid is reacted with epoxides.

DE-OS 1 644 798, DE-A1 27 37 406, EP-A1 53 749, DE-A1 195 25 489, EP-A1 942 022, EP-A1 928 800, EP-A2 1 085 065 and EP-A1 1 138 710 describe the reaction of isocyanates with hydroxyalkyl acrylates and further hydroxyl-containing compounds.

A disadvantage of the multilayer systems described in EP-A1 928 800 is that they are two-component systems where the user mixes an isocyanate component and a hydroxy component with one another just a short time before producing the coating. The coating properties may therefore easily be impaired as a result of incorrect proportioning.

DE-OS 21 15 373 describes the preparation of photosensitive compositions for printing plates, comprising polyurethane prepolymers whose hydroxy component contains at least 5 ether bonds. The requirements imposed on systems for printing plates, however, are completely different than those for coating systems.

A disadvantage of the processes described in the cited publications is that the radiation-curable compounds they can be used to obtain do not satisfy the present-day requirements in terms of abrasion resistance, chemical resistance, and toughness for coating systems.

It is an object of the present invention to develop one-component radiation-curable (meth)acrylates which score better for abrasion resistance, toughness with resilience, and chemical resistance than the prior art radiation-curable (meth)acrylates.

We have found that this object is achieved by a radiation-curable urethane (meth)acrylate obtainable by the steps comprising
a) partly reacting an alkoxylated polyol (A) with (meth)acrylic acid (B) in the presence of at least one esterification catalyst (C) and at least one polymerization inhibitor (D) and also if desired a solvent (E) that forms an azeotrope with water,
b) removing if desired at least some of the water formed in a) from the reaction mixture which can be done during and/or after a),
f) neutralizing if desired the reaction mixture,
h) removing if desired any solvent (E) used by distillation and/or
i) stripping with a gas which is inert under the reaction conditions,
k) reacting the reaction mixture obtained after the last of the above steps with a compound (G) containing at least two epoxy groups in the presence if desired of a catalyst (H), and
l) reacting the reaction mixture from k) with at least one polyisocyanate (J) and at least one hydroxyalkyl(meth)acrylate (K) and if desired with at least one further compound (M) containing one or more isocyanate-reactive groups in the presence if desired of a catalyst (L).

The term (meth)acrylic acid or (meth)acrylic ester is used representatively in this text for methacrylic acid and acrylic acid or, respectively, methacrylic ester and acrylic ester. The invention prefers acrylic acid.

Alkoxylated polyols (A) which can be used in accordance with the invention are compounds containing at least two hydroxyl functions (—OH), preferably at least three, more preferably from three to ten, very preferably from three to six, in particular three or four, and especially three.

The polyols can be aliphatic, cycloaliphatic or aromatic, preferably aliphatic or cycloaliphatic, and very preferably aliphatic, can be straight-chain or branched, and can if desired be substituted by functional groups.

The polyols generally have from 4 to 50 carbon atoms, preferably from 5 to 40, more preferably from 6 to 30, and very preferably from 8 to 26.

The molar weight of the polyols which can be used is generally, unless otherwise specified, below 2500 g/mol, preferably below 2000 g/mol, more preferably 106-1500 g/mol, very preferably 150-1200 g/mol, and in particular 170-1050 g/mol. The polydispersity (M_{w}:Mₙ) is generally from 1 to 5, preferably from 1 to 3.

Preferred polyols can also carry functional groups or can be unfunctionalized; preferably they do not carry any other functional groups.

Examples are trimethylolbutane, trimethylolpropane, trimethylolethane, neopentylglycol, neopentylglycol hydroxypivalate, pentaerythritol, glycerol, 1,2-ethylene glycol, 1,2-propylene glycol, 1,3-propanediol, 2-ethyl-1,3-propanediol, 2-methyl-1,3-propanediol, hydroquinone, bisphenol A, bisphenol F, bisphenol B, 2,2-bis(4-hydroxycyclohexyl)propane, 1,1-, 1,2-, 1,3-, and 1,4-cyclohexanedimethanol, 1,2-, 1,3- or 1,4-cyclohexanediol, but-2-ene-1,4-diol, and but-2-yne-1,4-diol.

The polyols may additionally carry functional groups as well, such as ether functions (—O—), carboxyl functions (—COOH) or C₁-C₆ alkyloxycarbonyl functions (ester groups), C₁-C₄ alkyl in this text denoting methyl, ethyl, iso-propyl, n-propyl, n-butyl, iso-butyl, sec-butyl or tert-butyl, and C₁-C₅ alkyl further denoting n-pentyl, iso-pentyl, neopentyl, n-hexyl, iso-hexyl or neo-hexyl.

Examples of such functionalized polyols are ditrimethylolpropane, dipentaerythritol, dimethylol-propionic acid, dimethylolbutyric acid, trimethylolacetic acid, hydroxypivalic acid, and the 2-hydroxyethyl esters or C₁-C₄ alkyl esters of these stated acids.

Particularly preferred polyols are those of the formula (I):

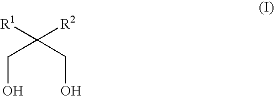

In this formula
R¹, R² independently are hydrogen, C₁-C₁₀ alkyl, preferably C₁-C₄ alkyl, C₁-C₁₀ hydroxyalkyl, preferably hydroxy-C₁-C₄ alkyl, carboxyl or C₁-C₄ alkyloxycarbonyl, preferably hydrogen, hydroxymethyl, and C₁-C₄ alkyl, and very preferably hydroxymethyl and C₁-C₄ alkyl.

The alkyl radicals can in each case be straight-chain or branched.

Examples of R¹ and R² are hydrogen, methyl, ethyl, isopropyl, n-propyl, n-butyl, iso-butyl, sec-butyl, tert-butyl, n-pentyl, n-hexyl, n-heptyl, n-octyl, n-decyl, hydroxymethyl, carboxyl, methoxy-carbonyl, ethoxycarbonyl or n-butoxycarbonyl, preferably hydrogen, hydroxymethyl, methyl, and ethyl, very preferably hydroxymethyl, methyl, and ethyl.

Particularly preferred polyhydric alcohols of the formula (I) are trimethylolbutane, trimethylolpropane, trimethylolethane, neopentylglycol, pentaerythritol, 2-ethyl-1,3-propanediol, 2-methyl-1,3-propanediol, 1,3-propanediol, dimethylolpropionic acid, methyl dimethylolpropionate, ethyl dimethylolpropionate, dimethylolbutyric acid, methyl dimethylolbutyrate or ethyl dimethylolbutyrate, preferably neopentylglycol, trimethylolpropane, pentaerythritol, and dimethylolpropionic acid, very preferably neopentylglycol, trimethylolpropane, and pentaerythritol, and in particular trimethylol-propane and pentaerythritol.

Examples of sugar alcohols as polyols are sorbitol, mannitol, maltitol, isomalt, diglycerol, threitol, erythritol, adonitol (ribitol), arabitol (lyxitol), xylitol, and dulcitol (galactitol).

Alkoxylated polyols (A) are hence inventively those obtainable by reacting a polyol with at least one alkylene oxide.

Preferred examples of such alkoxylated polyols are the alkoxylation products (IIa), (IIb) or (IIc) of polyols of the formula (I), 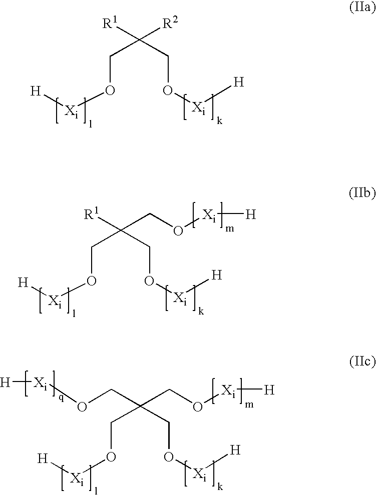
in which
R¹ and R² are as defined above,
k, l, m, and q independently are each an integer from 0 to 10, preferably from 2 to 7, more preferably from 3 to 6, and in particular 5, the sum k+l+m+q giving a result of from 1 to 20, and each Xᵢ, for i=1 to k, 1 to l, 1 to m and 1 to q, can be selected independently from CH₂CH₂O, CH₂CH(CH₃)O, CH(CH₃)CH₂O, CH₂C(CH₃)₂O, C(CH₃)₂CH₂O, CH₂CHVinO, CHVinCH₂O, CH₂CHPhO, and CHPhCH₂O, preferably from CH₂CH₂O, CH₂CH(CH₃)O, and CH(CH₃)CH₂O, and very preferably CH₂CH₂O,
   where Ph is phenyl and Vin is vinyl.

Among these polyhydric alcohols particular preference is given to those of the formula (IIb).

Preference here is given to a pentaerythritol, trimethylolethane or trimethylolpropane with from single to 20-fold, more preferably from 5- to 20-fold, very preferably 10-20-fold, and in particular 12-20-fold ethoxylation, propoxylation or mixed ethoxylation and propoxylation, and in particular exclusively ethoxylation.

The degrees of alkoxylation indicated refer in each case to the average degree of alkoxylation, so that statistically it is also possible for nonintegral degrees of alkoxylation to be present.

The figures for number-average and weight-average molecular weights Mₙ and M_{w} refer here to gel permeation chromatography measurements using polystyrene standards and tetrahydrofuran eluent. The method is described in Analytiker Taschenbuch vol. 4, pages 433 to 442, Berlin 1984.

The polydispersity M_{w}/Mₙ, the ratio of the weight-average to the number-average molecular weight of the alkoxylated polyols (A), is a measure of the molecular weight distribution and in an ideal case has a value of 1, although for practical purposes values below 4.0, preferably below 3.5, are generally sufficient.

Examples of alkoxylated sugar alcohols are those compounds obtainable from sugar alcohols—for example, the sugar alcohols recited above—by alkoxylation, with for example the alkylene oxides recited above, preferably with ethylene oxide and/or propylene oxide, and very preferably with ethylene oxide.

Examples thereof include
the recited tetrols, having on average per mole of sugar alcohol 2-30-fold, preferably 2-20-fold, more preferably 3-10-fold, and in particular 3-, 4-, 5-, 6,7- or 8-fold alkoxylation,
the recited pentols, having on average per mole of sugar alcohol 3-35-fold, preferably 3-28-fold, more preferably 4-20-fold, and in particular 4-, 5-, 6-, 7-, 8-, 9- or 10-fold alkoxylation,
higher sugar alcohols, having on average per mol of sugar alcohol 4-50-fold, preferably 6-40-fold, more preferably 7-30-fold, very preferably 8-20-fold, and in particular 10-15-fold alkoxylation.

The reaction of alcohols with an alkylene oxide is known per se to the skilled worker. Possible implementations can be found in Houben-Weyl, Methoden der Organischen Chemie, 4th edition, 1979, Thieme Verlag Stuttgart, ed. Heinz Kropf, volume 6/1a, part 1, pages 373 to 385.

Where alcohols with mixed alkoxylation are used the different alkoxy groups present therein can be in a molar ratio to one another of, for example, 0.05-20:1, preferably 0.1-10:1, and very preferably 0.2-5:1.

There are no particular requirements concerning the viscosity of the alkoxylated polyols (A) which can be used inventively except that they should be readily pumpable at a temperature of up to about 80° C.; preferably they should have a viscosity below 2000 mPas, more preferably below 1500 mPas, and very preferably below 1000 mPas at 60° C.

(Meth)acrylic acid (B) is, as mentioned above, methacrylic acid or, preferably, acrylic acid.

The alkoxylated polyols (A): (meth)acrylic acid (B) molar ratio in the esterification is for example 1:0.75-2.5, preferably 1:0.8-2, more preferably 1:0.9-1.5, and very preferably 1:1-1.2.

Esterification catalysts (C) are sulfuric acid, arene- or alkanesulfonic acids or mixtures thereof. Examples of arenesulfonic acids are benzenesulfonic acid, para-toluenesulfonic acid, and dode-cylbenzenesulfonic acid; examples of alkanesulfonic acids are methanesulfonic acid, ethanesulfonic acid, and trifluoromethanesulfonic acid. Strongly acidic ion exchangers or zeolites can also be used as esterification catalysts. Preference is given to para-toluenesulfonic acid, sulfuric acid, and ion exchangers.

Examples of polymerization inhibitors (D) which can be used include hydroquinone, hydroquinone monomethyl ether, 2,5-di-t-butylhydroquinone, 2,6-di-t-butyl-p-cresol, nitroso compounds such as isoalkyl nitrites, nitrosodiphenylamine or N-nitroso-cyclohexylhydroxylamine, methylene blue, phenothiazine, tannic acid or diphenylamine. In the context of the present invention it is also possible to use two or more of these polymerization inhibitors. The polymerization inhibitors are used in amounts of from 1 to 10 000 ppm, in particular from 100 to 1000 ppm, based in each case on the total batch.

Examples of further polymerization inhibitors include phenolic compounds, amines, nitro compounds, phosphorus compounds, sulfur compounds, hydroxylamines, and N-oxyls, and also mixtures thereof where appropriate.

Preferred polymerization inhibitors are those such as phenothiazine, N-oxyls or phenolic compounds.

N-Oxyls (nitroxyl or N-oxyl radicals, compounds containing at least one >NO. group) are, for example, 4-hydroxy-2,2,6,6-tetramethylpiperidine-N-oxyl or 4-oxo-2,2,6,6-tetramethylpiperidine-N-oxyl.

Phenolic compounds are, for example, alkylphenols, such as 2-tert-butyl-4-methylphenol, 6-tert-butyl-2,4-dimethylphenol, 2,6-di-tert-butyl-4-methylphenol, pyrocatechol (1,2-dihydroxybenzene), bisphenol A, bisphenol F, bisphenol B, Koresin® from BASF AG, Irganox®) 565, 1141, 1192, 1222, and 1425 from Ciba Spezialitätenchemie, aminophenols, such as para-aminophenol, nitrosophenols, such as para-nitrosophenol, alkoxyphenols, such as 2-methoxyphenol (guaiacol, pyrocatechol monomethyl ether), 2-ethoxyphenol, 2-isopropoxyphenol, 4-methoxyphenol (hydroquinone monomethyl ether), tocopherols, quinones and hydroquinones such as hydroquinone, 2,5-di-tert-butylhydroquinone, benzoquinone, p-phenoxyphenol, anthraquinone or 2,5-di-tert-amylhydroquinone.

Aromatic amines are, for example N,N-diphenylamine; phenylenediamines are, for example, N,N′-dialkyl-para-phenylenediamine, such as N,N′-di-sec-butyl-para-phenylenediamine; hydroxylamines are, for example, N,N-diethylhydroxylamine; phosphorus compounds are, for example, triphenylphosphine, triphenyl phosphite or triethyl phosphite; and sulfur compounds are, for example, diphenyl sulfide.

Preference is given to phenothiazine, p-aminophenol, p-nitrosophenol, 2-tert-butylphenol, 4-tert-butylphenol, 2,4-di-tert-butylphenol, 2-methyl-4-tert-butylphenol, 4-tert-butyl-2,6-dimethylphenol, hydroquinone and/or hydroquinone monomethyl ether, and N,N′-di-sec-butyl-para-phenylenediamine.

Very particular preference is given to phenothiazine and hydroquinone monomethyl ether and mixtures thereof.

In addition it is common to use phosphorus compounds, such as triphenylphosphine, triphenyl phosphite, hypophosphorous acid or triethyl phosphite, for example, alone or in combination with metal salts, such as the chlorides, dithiocarbamates, sulfates, salicylates or acetates of copper, manganese, cerium, nickel or chromium, for example.

There are no restrictions on the way the polymerization inhibitor is added. It can be added either individually or as a mixture, in liquid form or in the form of a solution in an appropriate solvent, in which case the solvent may itself be a polymerization inhibitor, as described, for example, in the earlier German patent application numbered 102 00 583.4.

When a mixture of two or more polymerization inhibitors is used they can also be dissolved independently of one another in different solvents.

To further support the stabilization it is possible for an oxygen-containing gas to be present, preferably air or an air/nitrogen (lean air) mixture.

Solvents (E) which can be used inventively are in particular those suitable for azeotropic removal of the water of reaction, if desired, especially aliphatic, cycloaliphatic, and aromatic hydrocarbons or mixtures thereof.

Preference is given to employing n-pentane, n-hexane, n-heptane, cyclohexane, methylcyclohexane, benzene, toluene or xylene. Particular preference is given to cyclohexane, methylcyclohexane, and toluene.

For the esterification it is possible to employ the methods of preparing and/or working up polyhydric alcohols that are known to the person skilled in the art, examples being those mentioned at the outset or those described in DE-A 199 41 136, DE-A 38 43 843, DE-A 38 43 854, DE-A 199 37 911, DE-A 199 29 258, EP-A 331,845, EP 554 651 or U.S. Pat. No. 4,187,383.

Generally speaking the esterification can be conducted as follows:

The esterification apparatus is composed of a stirred reactor, preferably a reactor with a circulation evaporator and an attached distillation unit with condenser and phase separation vessel.

The reactor can be, for example, a reactor with double-jacket heating and/or internal heating coils. It is preferred to use a reactor with an external heat exchanger and with natural or forced circulation, i.e., using a pump.

The reaction can of course also be conducted in a plurality of reaction zones by way of example in a reactor cascade comprising two to four, preferably two or three reactors.

Suitable circulation evaporators are known to the skilled worker and are described in, for example, R. Billet, Verdampfertechnik, HTB-Verlag, Bibliographisches Institut Mannheim, 1965, 53. Examples of circulation evaporators are tube-bundle heat exchangers, plate-type heat exchangers, etc.

The circulation system may also of course comprise two or more heat exchangers.

The distillation unit is of a design known per se. It may comprise a simple distillation unit, equipped where appropriate with a splashguard, or may be a rectification column. Suitable column internals are in principle all conventional internals, examples being trays, stacked packings and/or dumped packings. Among the trays, preference is given to bubble trays, sieve trays, valve trays, Thormann trays and/or dual-flow trays; of the dumped packings, those with rings, coils, saddles or meshes are preferred.

From 5 to 20 theoretical plates are generally sufficient.

The condenser and the separating vessel are of conventional design.

Carboxylic acid (B) and alkoxylated polyol (A) are generally employed in the esterification a) in a molar excess as indicated above with respect to the hydroxyl groups of the alcohol.

Suitable esterification catalysts (C) are those recited above.

They are used generally in an amount of 0.1-5% by weight, based on the esterification mixture, preferably 0.15-5%, more preferably 0.2-4%, and very preferably 0.25-3% by weight.

If necessary, the esterification catalyst can be removed from the reaction mixture using an ion exchanger. The ion exchanger may be added directly to the reaction mixture and removed subsequently by filtration, or the reaction mixture can be passed over an ion exchanger bed. The esterification catalyst is preferably left in the reaction mixture. If, however, the catalyst is an ion exchanger, it is preferably removed, by filtration for example.

To further support the stabilization it is possible for an oxygen-containing gas to be present, preferably air or an air/nitrogen mixture (lean air).

This oxygen-containing gas is preferably metered into the bottom area of a column and/or into a circulation evaporator and/or passed through and/or over the reaction mixture.

The polymerization inhibitor (mixture) D (as recited above) is used in a total amount of 0.01-1% by weight, based on the esterification mixture, preferably 0.02-0.8%, more preferably 0.05-0.5% by weight.

The polymerization inhibitor (mixture) (D) can be used, for example, as an aqueous solution or as a solution in a reactant or product.

b) The water of reaction formed during the reaction can be distilled off during or after the esterification a), an operation which can be assisted by means of a solvent which forms an azeotrope with water. Preferably the major part of the water formed during the esterification is separated off.

Suitable solvents (E) for azeotropic removal of the water of reaction include the compounds recited above.

It is preferred to conduct the esterification in the presence of a solvent.

The amount of solvent used is 5-100% by weight, preferably 10-100% by weight, more preferably from 15 to 100% by weight, based on the sum of polyalcohol and carboxylic acid (B).

Implementation without azeotrope formers, however, is also conceivable, as described for example in DE-A1 38 43 854, column 2 line 18 to column 4 line 45, but differing therefrom in including the abovementioned stabilizers.

If the water present in the reaction mixture is not removed using an azeotrope-forming solvent, then it is possible to remove it by stripping with an inert gas, preferably an oxygen-containing gas, more preferably normal air or lean air, as described in DE-A 38 43 843, for example.

The reaction temperature of the esterification a) is generally 40-160° C., preferably 60-140° C., and very preferably 80-120° C. During the course of the reaction the temperature may remain the same or may rise; preferably it is raised during the course of the reaction. In this case the final esterification temperature is around 5-30° C. higher than the initial temperature. The esterification temperature can be determined and regulated by varying the solvent concentration of the reaction mixture, as described in DE-A 199 41 136 and in the German application numbered 100 63 175.4.

If a solvent is used it can be removed from the reaction mixture by distillation using the distillation unit attached to the reactor.

The distillate can either be removed or, after condensation, can be passed into a phase separation apparatus. The aqueous phase thus obtained is generally removed in circulation; the organic phase can be passed back as a return flow into the distillation unit and/or passed directly into the reaction zone and/or passed into a circulation evaporator, as described in the German patent application numbered 100 63 175.4.

In the case of its use as a return flow the organic phase can be used to control the temperature in the esterification, as described in DE-A 199 41 136.

The esterification a) can be conducted at atmospheric or else at superatmospheric or subatmospheric pressure, but is preferably operated at atmospheric pressure.

The reaction time is generally 2-20 hours, preferably 4-17 hours, and more preferably from 7 to 15 hours.

The sequence in which the individual reaction components are added is not critical to the invention. All of the components can be introduced as a mixture and then heated, or one or more components, or some of each of them, can be omitted from the initial charge and instead added only after the heating operation.

There is no restriction on the composition of the carboxylic acid (B) which can be used, and in the case of crude (meth)acrylic acid it may contain, for example, the following components:

| | |
|---|---|
| (Meth)acrylic acid | 90-99.9% by weight |
| Acetic acid | 0.05-3% by weight |
| Propionic acid | 0.01-1% by weight |
| Diacrylic acid | 0.01-5% by weight |
| Water | 0.05-5% by weight |
| Carbonyls | 0.01-0.3% by weight |
| Inhibitors | 0.01-0.1% by weight |
| Maleic acid (anhydride) | 0.001-0.5% by weight |

The crude (meth)acrylic acid used is generally stabilized with 50-600 ppm of phenothiazine or other stabilizers in amounts which provide comparable stabilization. The carbonyls in the above list are a reference here, for example, to acetone and lower aldehydes, such as formaldehyde, acetaldehyde, crotonaldehyde, acrolein, 2- and 3-furfural, and benzaldehyde, for example.

Crude (meth)acrylic acid here is the (meth)acrylic acid-containing mixture which is obtained after absorption of the reaction gases from the oxidation of propane/propene/acrolein or, respectively, isobutane/isobutene/methacrolein in an absorbent and subsequent separation of the absorbent, or the mixture obtained by fractional condensation of the reaction gases.

It is of course also possible to use pure (meth)acrylic acid here, with the following purity for example:

| | | |
|---|---|---|
| (Meth)acrylic acid | 99.7-99.99% | by weight |
| Acetic acid | 50-1000 | ppm by weight |
| Propionic acid | 10-500 | ppm by weight |
| Diacrylic acid | 10-500 | ppm by weight |
| Water | 50-1000 | ppm by weight |
| Carbonyls | 1-500 | ppm by weight |
| Inhibitors | 1-300 | ppm by weight |
| Maleic acid (anhydride) | 1-200 | ppm by weight |

The pure (meth)acrylic acid used is generally stabilized with 100-200 ppm of hydroquinone monomethyl ether or other storage stabilizers in amounts which provide comparative stabilization.

By pure or prepurified (meth)acrylic acid is meant generally (meth)acrylic acid whose purity is at least 99.5% by weight and which is substantially free from the aldehyde components, other carbonyl components, and high-boiling components.

The aqueous phase of the condensate separated off by way of the attached column, where present, which phase is distilled off during the esterification and can contain in general 0.1-10% by weight of carboxylic acid (B), (meth)acrylic acid for example, is separated off and removed. The carboxylic acid ((meth)acrylic acid, for example) it contains can advantageously be extracted with an extractant, preferably the solvent used where appropriate in the esterification, cyclohexane for example, at a temperature of between 10 and 40° C. with a ratio of aqueous phase to extractant of 1:5-30, preferably 1:10-20, and can be recycled to the esterification.

To further support the circulation it is possible to pass an inert gas, preferably an oxygen-containing gas, more preferably air or an air/nitrogen mixture (lean air) into the circulation, through or above the reaction mixture, in amounts for example of 0.1-1, preferably 0.2-0.8, and more preferably 0.3-0.7 m³ of oxygen-containing gas per m³ of volume of the reaction mixture per hour.

The progress of the esterification a) can be followed by monitoring the amount of water discharged and/or the decrease in the carboxylic acid concentration in the reactor.

The reaction can be ended, for example, when 75% of the theoretical amount of water has been discharged through the solvent, preferably at least 80%, and more preferably at least 85%.

The end of the reaction can be ascertained, for example, by the substantial absence of any further water of reaction removed via the azeotrope former. If carboxylic acid (B) is discharged together with the water of reaction, its fraction can be determined, for example, by back-titration of an aliquot of the aqueous phase.

It is also possible to forego removing the water of reaction, or at least some of it. In this case a substantial portion of the amount of water formed remains in the reaction mixture. During or after the reaction the only fraction of water removed from the reaction mixture is that which is determined by the volatility of the applied temperature, and no other measures are taken to separate off the water of reaction formed. Thus, for example, at least 10% by weight of the water of reaction formed can remain in the reaction mixture, preferably at least 20% by weight, more preferably at least 30% by weight, very preferably at least 40% by weight, and in particular at least 50% by weight.

c) After the end of the esterification the reactor mixture can be cooled conventionally to a temperature

of from 10 to 30° C., and where appropriate, by adding solvent, which may be the same as that used where appropriate for the azeotropic removal of water, or a different solvent, a desired concentration of target ester can be set.

d) The reaction mixture can be subjected if necessary to a decolorizing operation, by treatment for example with activated carbon or metal oxides, such as alumina, silica, magnesium oxide, zirconium oxide, boron oxide or mixtures thereof, for example, in amounts of for example 0.1-50% by weight, preferably from 0.5 to 25% by weight, more preferably 1-10% by weight, at temperatures of, for example, from 10 to 100° C., preferably from 20 to 80° C., and more preferably from 30 to 60° C.

This can be done by adding the decolorizer in powder or granule form to the reaction mixture, followed by filtration, or by passing the reaction mixture over a bed of the decolorizer in the form of any desired, suitable shapes.

The reaction mixture can be decolorized at any point in the workup procedure: for example, at the stage of the crude reaction mixture, or after any preliminary washing, neutralization or removal of solvent.

The reaction mixture can further be subjected to a preliminary wash e) and/or a neutralization f) and/or a subsequent wash g), preferably just a neutralization f). If desired, the order in which neutralization f) and preliminary wash e) are carried out can also be reversed.

From the aqueous phase of washing e) and g) and/or neutralization f) it is possible for at least some of the carboxylic acid (B) present, (meth)acrylic acid for example, and/or catalyst (C) to be recovered by acidification and extraction with a solvent, and used again.

For the preliminary or subsequent wash e) or g) the reaction mixture is treated in a scrubber with a wash liquid, which is, for example, water or a 5-30% by weight strength, preferably 5-20%, more preferably 5-15% strength by weight sodium chloride, potassium chloride, ammonium chloride, sodium sulfate or ammonium sulfate solution, preferably water or sodium chloride solution.

The reaction mixture to wash liquid ratio is generally 1:0.1-1, preferably 1:0.2-0.8, more preferably 1:0.3-0.7.

Washing or neutralization may be carried out, for example, in a stirred tank or in other conventional apparatus, e.g., in a column or mixer-settler apparatus.

For washing or neutralization in the process of the invention it impossible, in terms of process engineering, to use any of the extraction and washing techniques that are known per se, examples being those described in Ullmann's Encyclopedia of Industrial Chemistry, 6th ed., 1999 Electronic Release, chapter: Liquid—Liquid Extraction—Apparatus. These may be, for example, single-stage or multistage, preferably single-stage, extractions, and those carried out in cocurrent or countercurrent mode, preferably in countercurrent mode.

Preference is given to using sieve tray columns or columns packed with stacked or dumped packings, or else to using stirred tanks or mixer-settler apparatus, and also pulsed columns or those having rotating internals.

The preliminary wash e) is preferably employed when metal salts, preferably copper or copper salts, are (among) the inhibitors used.

A subsequent wash g) may be advantageous in order to remove traces of base or of salt from the reaction mixture neutralized in f).

For neutralization f) the reaction mixture, which may still contain small amounts of catalyst and the major amount of excess carboxylic acid, (meth)acrylic acid for example, after preliminary washing where appropriate, can be neutralized with an aqueous solution having a strength of 5 25%, preferably 5-20%, more preferably 5-15% by weight of a base, such as, for example, alkali metal or alkaline earth metal oxides, hydroxides, carbonates or hydrogencarbonates, preferably sodium hydroxide, potassium hydroxide, sodium hydrogencarbonate, sodium carbonate, potassium hydrogencarbonate, calcium hydroxide, milk of lime, ammonia, aqueous ammonia or potassium carbonate, to which if desired 5-15% by weight of sodium chloride, potassium chloride, ammonium chloride or ammonium sulfate may have been added, more preferably with sodium hydroxide or sodium hydroxide/sodium chloride solution. The degree of neutralization is preferably from 5 to 60 mol %, more preferably from 10 to 40 mol %, very preferably from 20 to 30 mol %, based on the monomers containing acid groups.

The base is added such that the temperature in the apparatus does not rise above 60° C., remaining preferably between 20 and 35° C., and the pH is 4-13. The heat of neutralization is removed preferably by cooling the vessel by means of internal cooling coils or via double-jacket cooling.

The reaction mixture to neutralization liquid ratio is generally 1:0.1-1, preferably 1:0.2-0.8, more preferably 1:0.3-0.7.

As far as the apparatus is concerned, the comments made above apply.

h) If a solvent is present in the reaction mixture it can be removed substantially by means of distillation. Preferably, any solvent present is removed from the reaction mixture after washing and/or neutralization; if desired, however, this can also be done before washing and/or neutralization.

For this purpose it is possible to admix the reaction mixture with an amount of storage stabilizer, preferably hydroquinone monomethyl ether, such that after the solvent has been removed the residue thereof in the target ester is 100-500 ppm, preferably 200-500 ppm, more preferably 200-400 ppm.

The distillative separation of the major amount of solvent takes place for example in a stirred tank with jacket heating and/or internal heating coils under reduced pressure, for example at 20-700 mbar, preferably from 30 to 500 mbar, and more preferably 50-150 mbar, and at a temperature of 40-120° C.

The distillation can of course also take place in a falling film or thin-film evaparator. For this purpose the reaction mixture, preferably two or more times in circulation, is passed through the apparatus under reduced pressure, for example, at 20-700 mbar, preferably from 30 to 500 mbar, and more preferably 50-150 mbar, and at a temperature of 40-80° C.

An advantageous possibility is to introduce an inert gas, preferably an oxygen-containing gas, more preferably air or an air/nitrogen mixture (lean air) into the distillation apparatus, at for example 0.1-1, preferably 0.2-0.8, and more preferably 0.3-0.7 m³ of oxygen-containing gas per m³ of reaction mixture per hour.

The residual solvent content in the residue after distillation is generally below 5% by weight, preferably 0.5-5%, and more preferably 1-3% by weight.

The solvent separated off is condensed and preferably used again.

Distillation can be replaced or supplemented if necessary by solvent stripping i).

For this purpose the target ester, still containing small amounts of solvent, is heated to 50-90° C., preferably 80-90° C., and the remaining quantities of solvent are removed using a suitable gas in an appropriate apparatus. Reduced pressure may also be applied to assist the process, if desired.

Examples of suitable apparatus include columns of a design known per se, containing the usual internals, e.g., trays, dumped packings or ordered packings, preferably dumped packings. Suitable column internals include in principle all customary internals, examples being trays, stacked packings and/or dumped packings. Among the trays, preference is given to bubble trays, sieve trays, valve trays, Thormann trays and/or dual-flow trays; among the dumped packings, those comprising rings, coils, saddles, Raschig, Intos or Pall rings, barrel saddles or Intalox saddles, Top-Pak, etc. or meshes are preferred.

Also suitable here is a falling film, thin film or wiped film evaporator, such as a Luwa, Rotafilm or Sambay evaporator, which may be equipped with a demister, for example, as a splashguard.

Suitable gases are gases which are inert under the stripping conditions, preferably oxygen-containing gases, more preferably air or air/nitrogen mixtures (lean air) or water vapor, especially those which have been conditioned to a temperature of from 50 to 100° C.

The amount of stripping gas is for example 5-20, more preferably 10-20, and very preferably from 10 to 15 m³ of stripping gas per m³ of reaction mixture per hour.

Excess acrylic acid is distilled off from the reaction mixture where appropriate under reduced pressure.

If necessary, at any desired stage in the workup process, preferably after washing/neutralization and, where appropriate, after solvent removal, the esterification mixture may be subjected to a filtration j) in order to remove traces of precipitated salts and also any decolorizer present.

Furthermore, the esterification catalyst (C) used remains essentially in the reaction mixture.

It is preferred to omit a preliminary wash or subsequent wash e) or g); just a filtration step j) may be rational. It is likewise preferred to forego a neutralization f).

The sequence of steps c), j), and, where practiced, f) is arbitrary.

The reaction mixture from the esterification that is obtainable in this way has an acid number to DIN EN 3682 of generally up to 200 mg KOH/g, preferably from 5 to 100, more preferably from 5 to 50, and very preferably from 5 to 30 mg KOH/g, and an OH number to DIN 53240 of up to 120 mg KOH/g, preferably from 10 to 100, more preferably from 15 to 70, and very preferably from 20 to 90 mg KOH/g.

The mixture contains essentially from 20% up to 80% by weight of fully esterified alkoxylated polyol (A), from 20 to 50% by weight of unesterified or partly esterified alkoxylated polyol (A), from 0.001% up to 25% by weight of unreacted (meth)acrylic acid (B), from 0.1 to 5% by weight of esterification catalyst (C), and from 0.01 to 1% by weight of polymerization inhibitor (D), and also, where appropriate, solvent (E), with the proviso that the total amount is 100% by weight.

k) The reaction mixture from the esterification that is obtained thus after the last of the above reaction steps is used in a downstream stage in which it is reacted with a compound (G) containing at least two alkylene oxide units.

Epoxide compounds (G) which can be used are those containing at least two, preferably two to four, more preferably two or three, and very preferably two epoxide groups per molecule.

Suitable examples include glycidyl ethers of aliphatic or aromatic polyols. Products of this kind are available commercially in large numbers. Particular preference is given to polyglycidyl compounds of the bisphenol A, F or B type, their fully hydrogenated derivatives, and glycidyl ethers of polyhydric alcohols, e.g., of 1,4-butanediol, 1,4-cyclohexanedimethanol, neopentylglycol, of 1,6-hexanediol, of glycerol, trimethylolpropane, and of pentaerythritol. Examples of such polyepoxide compounds are Epikote® 812 and Epikote® 828, Epikote® 1001, Epikote® 1007, and Epikote® 162 from Resolution Performance Products, Rutapox® 0162, Rutapox®) 0164, and Rutapox®) 0165 from Bakelite AG, and Araldit® DY 0397 from Vantico AG.

Very particular preference is given to bisphenol A diglycidyl ether, 1,4-butanediol diglycidyl ether, trimethylolpropane triglycidyl ether, and pentaerythritol tetraglycidyl ether, especially bisphenol A diglycidyl ether.

The epoxide compounds (G) are added to the reaction mixture from the esterification in amounts of generally 5-60% by weight, preferably 5-30% by weight, and more preferably 5-20% by weight, based on the reaction mixture (excluding solvent). With very particular preference the epoxide compounds are used in approximately equimolar amounts relative to the acid equivalents still present in the reaction mixture: for example, an epoxide group to acid group ratio of 0.8-2.5:1, preferably 0.9-2.0:1, more preferably 1.0-1.5:1, and very preferably 1.0-1.2:1 mol/mol.

In the reaction with the epoxide compounds (G) acid used in excess and/or unreacted, especially (meth)acrylic acid, is bound in epoxide ester form, as are also, for example, hydroxy compounds still present as starting material in the mixture.

The reaction with epoxide compounds takes place preferably at from 90 to 130° C., more preferably from 100 to 110° C., and is continued until the reaction mixture has an acid number to DIN EN 3682 of less than 5, more preferably less than 2 mg KOH/g (excluding solvent).

Catalysts (H) which can be used for the reaction with the epoxide compounds in step k) include, for example, quaternary ammonium compounds and phosphonium compounds, tertiary amines, phosphines such as triphenylphosphine, and Lewis bases such as thiodiglycol.

The catalysts are used preferably in amounts of from 0.01 to 5%, more preferably from 0.1 to 3% by weight, based on the reaction mixture.

The temperature of the reaction is at least 40° C., preferably from 40 to 130° C., more preferably from 50 to 120° C., and very preferably from 60 to 120° C.

The reaction mixture obtainable in this way from the epoxidation has an acid number to DIN EN 3682 of generally less than 5, preferably less than 4 mg KOH/g and an OH number to DIN 53240 of up to 250 mg KOH/g, preferably up to 150, more preferably from 10 to 100, and very preferably from 20 to 90 mg KOH/g.

The mixture contains essentially from 20 up to 80% by weight of fully esterified polyol (A), from 20 to 50% by weight of unesterified or partly esterified polyol (A), from 0.001 up to 25% by weight of epoxidized unesterified or partly esterified polyol (A), from 0.1 to 15% by weight of epoxy esters of (meth)acrylic acid, esterification catalysts and polymerization inhibitor, traces of unreacted (meth)acrylic acid, and, where appropriate, solvent, with the proviso that the total amount is 100% by weight.

l) The reaction mixture obtainable in this way from k) is used in a downstream stage in which it is reacted with at least one polyisocyanate (J) and with at least one hydroxyalkyl l(meth)acrylate (K) and also if desired at least one compound (M) containing one or more isocyanate-reactive groups.

Examples of suitable polyisocyanates (J) include aliphatic, aromatic, and cycloaliphatic diisocyanates and polyisocyanates having an NCO functionality of at least 1.8, preferably from 1.8 to 5, and more preferably from 2 to 4, and also their isocyanurates, biurets, allophanates, and uretdiones.

The diisocyanates are preferably isocyanates having 4 to 20 carbon atoms. Examples of customary diisocyanates are aliphatic diisocyanates such as tetramethylene diisocyanate, hexamethylene diisocyanate (1,6-diisocyanatohexane), octamethylene diisocyanate, decamethylene diisocyanate, dodecamethylene diisocyanate, tetradecamethylene diisocyanate, derivatives of lysine diisocyanate, trimethylhexane diisocyanate or tetramethylhexane diisocyanate, cycloaliphatic diisocyanates such as 1,4-, 1,3- or 1,2-diisocyanatocyclohexane, 4,4′- or 2,4′-di(isocyanatocyclohexyl)methane, 1-isocyanato-3,3,5-trimethyl-5-(isocyanatomethyl)-cyclohexane (isophorone diisocyanate), 1,3- or 1,4-bis(isocyanatomethyl)cyclohexane or 2,4- or 2,6-diisocyanato-1-methylcyclohexane, and aromatic diisocyanates such as 2,4- or 2,6-tolylene diisocyanate and the isomer mixtures thereof, m- or p-xylylene diisocyanate, 2,4′- or 4,4′-diisocyanatodiphenylmethane and the isomer mixtures thereof, 1,3- or 1,4-phenylene diisocyanate, 1-chloro-2,4-phenylene diisocyanate, 1,5-naphthylene diisocyanate, diphenylene 4,4′-diisocyanate, 4,4′-diisocyanato-3,3′-dimethylbiphenyl, 3-methyldiphenylmethane 4,4′-diisocyanate, tetramethylxylylene diisocyanate, 1,4-diisocyanatobenzene or diphenyl ether 4,4′-diisocyanate.

Mixtures of said diisocyanates may also be present.

Preference is given to 2,4- or 2,6-tolylene diisocyanate and the isomer mixtures thereof, hexa-methylene diisocyanate, 1,3-bis(isocyanatomethyl)cyclohexane, isophorone diisocyanate, and di(isocyanatocyclohexyl)methane.

Suitable polyisocyanates include polyisocyanates containing isocyanurate groups, uretdione diisocyanates, polyisocyanates containing biuret groups, polyisocyanates containing urethane or allophanate groups, polyisocyanates containing oxadiazinetrione groups, uretonimine-modified polyisocyanates of linear or branched C₄-C₂₀ alkylene diisocyanates, cycloaliphatic diisocyanates having 6 to 20 carbon atoms in total or aromatic diisocyanates having 8 to 20 carbon atoms in total, or mixtures thereof.

The diisocyanates and polyisocyanates which can be used preferably have an isocyanate group content (calculated as NCO, molecular weight=42) of from 10 to 60% by weight, based on the diisocyanate and polyisocyanate (mixture), more preferably from 15 to 60% by weight, and very preferably from 20 to 55% by weight.

Preference is given to aliphatic and/or cycloaliphatic diisocyanates and polyisocyanates, examples being the aliphatic and cycloaliphatic diisocyanates specified above, or mixtures thereof.

Preference is also given to
1) polyisocyanates which contain isocyanurate groups and are derived from aromatic, aliphatic and/or cycloaliphatic diisocyanates. Particularly preferred in this context are the corresponding aliphatic and/or cycloaliphatic isocyanato-isocyanurates and, in particular, those based on hexamethylene diisocyanate and isophorone diisocyanate. The isocyanurates present are, in particular, trisisocyanatoalkyl or trisisocyanatocycloalkyl isocyanurates, which represent cyclic trimers of the diisocyanates, or mixtures with their higher homologs containing more than one isocyanurate ring. The isocyanato-isocyanurates generally have an NCO content of from 10 to 30% by weight, in particular from 15 to 25% by weight, and an average NCO functionality of from 3 to 4.5.
2) uretdione diisocyanates containing aromatically, aliphatically and/or cycloaliphatically attached isocyanate groups, preferably aliphatically and/or cycloaliphatically attached isocyanate groups, and in particular those derived from hexamethylene diisocyanate or isophorone diisocyanate. Uretdione diisocyanates are cyclic dimerization products of diisocyanates.
   The uretdione diisocyanates can be used in the formulations of the invention as a sole component or in a mixture with other polyisocyanates, particularly those specified under 1).
3) polyisocyanates containing biuret groups and containing aromatically, cycloaliphatically or aliphatically attached, preferably cycloaliphatically or aliphatically attached isocyanate groups, particularly tris(6-isocyanatohexyl)biuret or its mixtures with its higher homologs. These polyisocyanates containing biuret groups generally have an NCO content of from 18 to 22% by weight and an averabe NCO functionality of from 3 to 4.5.
4) polyisocyanates containing urethane and/or allophanate groups and having aromatically, aliphatically or cycloaliphatically, preferably aliphatically or cycloaliphatically, attached isocyanate groups, such as may be obtained, for example, by reacting excess quantities of hexamethylene diisocyanate or of isophorone diisocyanate with polyhydric alcohols such as, for example, trimethylolpropane, neopentylglycol, pentaerythritol, 1,4-butanediol, 1,6-hexanediol, 1,3-propanediol, ethylene glycol, diethylene glycol, glycerol, 1,2-dihydroxypropane or mixtures thereof. These polyisocyanates containing urethane and/or allophanate groups have an NCO content of generally from 12 to 20% by weight and an average NCO functionality of from 2.5 to 3.
5) polyisocyanates containing oxadiazinetrione groups, preferably derived from hexamethylene diisocyanate or isophorone diisocyanate. Polyisocyanates of this kind containing oxadiazinetrione groups can be prepared from diisocyanate and carbon dioxide.
6) uretonimine-modified polyisocyanates.

The polyisocyanates 1) to 6) can be used in a mixture, including if desired a mixture with diisocyanates.

Suitable hydroxyalkyl (meth)acrylates (K) are compounds which carry at least one, preferably 1-3, more preferably 1-2, and very preferably one hydroxyl group and at least one, preferably 1-3, more preferably 1-2, and very preferably one (meth)acrylate group.

Hydroxyalkyl (meth)acrylates (K) can be, for example, monoesters of (meth)acrylic acid with diols or polyols which contain preferably from 2 to 20 carbon atoms and have at least two, preferably two, hydroxyl groups, such as ethylene glycol, diethylene glycol, triethylene glycol, 1,2-propylene glycol, 1,3-propylene glycol, 1,1-dimethyl-1,2-ethanediol, dipropylene glycol, triethylene glycol, tetraethylene glycol, pentaethylene glycol, tripropylene glycol, 1,4-butanediol, 1,5-pentanediol, neopentylglycol, 1,6-hexanediol, 2-methyl-1,5-pentanediol, 2-ethyl-1,4-butanediol, 1,4-dimethylolcyclohexane, glycerol, trimethylolethane, trimethylolpropane, trimethylolbutane, pentaerythritol, ditrimethylolpropane, erythritol, sorbitol, polyTHF with a molar weight of between 162 and 378, poly-1,3-propanediol with a molar weight of between 134 and 400 or polyethylene glycol with a molar weight of between 238 and 458.

Preference is given to using 2-hydroxyethyl (meth)acrylate, 2- or 3-hydroxypropyl (meth)acrylate, 1,4-butanediol mono(meth)acrylate, neopentylglycol mono(meth)acrylate, glyceryl mono(meth)acrylate and di(meth)acrylate, trimethylolpropane mono(meth)acrylate and di(meth)acrylate, pentaerythritol mono-, di-, and tri(meth)acrylate. Particular preference is given to 2-hydroxyethyl acrylate, 2-hydroxyethyl methacrylate, 2- or 3-hydroxypropyl acrylate, 1,4-butanediol monoacrylate, and 3-(acryloyloxy)-2-hydroxypropyl methacrylate, and very particular preference to 2-hydroxyethyl acrylate and 2-hydroxyethyl methacrylate.

If desired it is possible to add compounds (M) during or after the end of the reaction of the reaction mixture from k) with (J) and (K).

These compounds (M) are compounds containing one or more isocyanate-reactive groups. They can be for example, C₁-C₂₀ monoalcohols, mercaptans or monoamines, preferably mono-alcohols, e.g., methanol, ethanol, iso-propanol, n-propanol, n-butanol, iso-butanol, sec-butanol, tert-butanol, ethylene glycol monomethyl ether, ethylene glycol monoethyl ether, diethylene glycol monomethyl ether, diethylene glycol monoethyl ether, 1,3-propandiol monomethyl ether, 1,2-propanediol monoethyl ether, 1,2-propanediol monomethyl ether, n-hexanol, n-heptanol, n-octanol, n-decanol, n-dodecanol, 2-ethylhexanol, cyclopentanol, cyclohexanol, cyclooctanol, cyclododecanol, triethylene glycol monomethyl ether, triethylene glycol monoethyl ether, n-pentanol, stearyl alcohol, cetyl alcohol, lauryl alcohol, cyclopent-2-en-1-ol, cyclopent-3-en-1-ol, cyclohex-2-en-1-ol, allyl alcohol, methylamine, ethylamine, iso-propylamine, n-propylamine, n-butylamine, iso-butylamine, sec-butylamine, tert-butylamine, n-pentylamine, n-hexylamine, n-heptylamine, n-octylamine, n-decylamine, n-dodecylamine, 2-ethylhexylamine, stearylamine, cetylamine, laurylamine, dimethylamine, diethylamine, di-n-propylamine, di-iso-propylamine, di-n-butylamine, dihexylamine, dioctylamine, ethylmethylamine, iso-propylmethylamine, n-butylmethylamine, tert-butylmethylamine, iso-propylethylamine, n-butylethylamine, tert-butylethylamine, cyclopentylamine, cyclohexylamine, cyclooctylamine, cyclododecylamine, morpholine, piperidine, pyrrolidine, N-methylpiperazine, monoethanolamine, monopropanolamine, dipropanolamine, methanethiol, ethanethiol, iso-propanethiol, n-propanethiol, n-butanethiol, iso-butanethiol, sec-butanethiol or tert-butanethiol.

For each NCO mol equivalent in (J) use is made of 0.05-0.6 mol of (K) and 0.2-0 mol of (M), the sum of the amounts of (K)+(M) corresponding to the NCO mol equivalents reduced by the molar amount of OH groups and acid groups in the reaction mixture from step k).

To accelerate the reaction it is possible if desired to use suitable catalysts (L).

These are the customary catalysts known for these purposes, examples being metal carboxylates, metal chelates or tertiary amines of the type described in GB-A-0 994 890, alkylating agents of the type described in U.S. Pat. No. 3,769,318, or strong acids as described by way of example in EP-A-0 000 194.

Suitable catalysts include, in particular, zinc compounds, such as zinc(II) stearate, zinc(II) n-octanoate, zinc(II) 2-ethylhexanoate, zinc(II) naphthenate or zinc(II) acetylacetonate, for example, tin compounds, such as tin(II) n-octanoate, tin(II) 2-ethylhexanoate, tin(II) laurate, dibutyltin oxide, dibutyltin dichloride, dibutyltin diacetate, dibutyltin dilaurate, dibutyltin dimaleate or dioctyltin diacetate, for example, aluminum tri(ethyl acetoacetate), iron(III) chloride, potassium octoate, manganese, cobalt or nickel compounds, and also strong acids, such as trifluoroacetic acid, sulfuric acid, hydrogen chloride, hydrogen bromide, phosphoric acid or perchloric acid, for example, or any desired mixtures of these catalysts.

Suitable, albeit less preferred catalysts for the process are also those catalysts which are described in, for example, EP-A-0 649 866 page 4 line 7 to page 5 line 15.

Preferred catalysts for the process of the invention are zinc compounds of the type mentioned above. Very particular preference is given to using zinc(II) n-octanoate, zinc(II) 2-ethylhexanoate and/or zinc(II) stearate.

These catalysts are employed, if at all, in an amount of from 0.001 to 5% by weight, preferably from 0.005 to 1% by weight, based on the total weight of the reactants.

The reaction can take place with particular preference in the presence of cesium salts, as described in the earlier German patent application numbered 10161156.0 and filed Dec. 12, 2001. Preferred cesium salts in this context are compounds in which the following anions are used: F, Cl⁻, ClO⁻, ClO₃₋, ClO₄⁻, Br⁻, I⁻, IO₃⁻, CN⁻, OCN⁻, NO₂⁻, NO₃⁻, HCO₃⁻, CO₃²⁻, S²⁻, SH⁻, HSO₃⁻, SO₃²⁻, HSO₄⁻, SO₄²⁻, S₂O₂²⁻, S₂O₄²⁻, S₂O₅²⁻, S₂O₆²⁻, S₂O₇²⁻, S₂O₈²⁻, H₂PO₂⁻, H₂PO₄₋, HPO₄²⁻, PO₄³⁻, P₂O₇⁴⁻, (OCₙH₂ₙ₊₁)⁻, (CₙH₂ₙ₋₁O₂)⁻, (CₙH₂ₙ₋₃O₂)⁻, and (Cₙ₊₁H₂ₙ₋₂O₄)²⁻, where n stands for the numbers 1 to 20.

Particular preference here is given to cesium carboxylates, in which the anion conforms to the formulae (CₙH₂ₙ₋₁O₂)⁻ and (Cₙ₊₁H₂ₙ₋₂O₄)²⁻ with n being from 1 to 20. Especially preferred cesium salts have monocarboxylate anions of the general formula (CₙH₂ₙ₋₁O₂)⁻, where n is a number from 1 to 20. Particular mention may be made here of formate, acetate, propionate, hexanoate, and 2-ethylhexanoate.

The cesium salts are used in amounts of from 0.01 to 10 mmol of cesium salt per kg of solvent-free batch. They are preferably used in amounts of from 0.05 to 2 mmol of cesium salt per kg of solvent-free batch.

The cesium salts can be added to the batch in solid form, but preferably in dissolved form. Suitable solvents include polar aprotic solvents or else protic solvents. Particular suitability besides water is possessed by alcohols; especially suitable are polyols, such as are otherwise used as building blocks for polyurethanes, such as ethane-, propane-, and butanediols, for example. Using the cesium salts allows the polyaddition to be conducted under the customary conditions.

The reaction mixture (N) obtainable by reaction of polyisocyanate (J) generally has no significant acid number, no significant OH number (each <5, preferably <3, more preferably <2, and in particular <1 mg KOH/g), and has an NCO content (calculated as NCO, molar weight 42 g/mol) of <0.5, preferably <0.3, more preferably <0.2, and very preferably <0.1% by weight.

The reaction mixture (N) of the invention that is obtainable in this way can be used for radiation-curable coating systems or coating materials, which in addition to the reaction mixture (N) of the invention may also comprise reactive diluents (O), photoinitiators (P), and other typical coatings additive (O).

Suitable reactive diluents (compounds (O)) include radiation-curable, free-radically or cationically polymerizable compounds having only one ethylenically unsaturated copolymerizable group.

Examples of suitable radiation-curable, free-radically polymerizable reactive diluents are the triacrylic esters of trimethylolpropane, tetraacrylic esters of pentaerythritol, and the ethoxylated and/or propoxylated derivatives thereof, diacrylic esters of dipropylene glycol, tripropylene glycol, diethylene glycol, 1,2-ethanediol, 1,3- or 1,4-butanediol or 1,6-hexanediol.

Mention may also be made, for example, of C₁-C₂₀ alkyl (meth)acrylates and of vinylaromatics having up to 20 carbon atoms.

Preferred (meth)acrylic acid alkyl esters are those having a C₁-C₁₀ alkyl radical, such as methyl methacrylate, methyl acrylate, n-butyl acrylate, ethyl acrylate, and 2-ethylhexyl acrylate.

In particular, mixtures of the (meth)acrylic acid alkyl esters are also suitable.

Examples of suitable vinylaromatic compounds include vinyltoluene, α-butylstyrene, 4-n-butylstyrene, 4-n-decylstyrene, and, preferably, styrene.

As photoinitiators (P) it is possible to use photoinitiators known to the skilled worker, examples being those specified in “Advances in Polymer Science”, Volume 14, Springer Berlin 1974 or in K. K. Dietliker, Chemistry and Technology of UV and EB Formulation for Coatings, Inks and Paints, Volume 3; Photoinitiators for Free Radical and Cationic Polymerization, P. K. T. Oldring (Eds.), SITA Technology Ltd, London.

Examples include mono- or bisacylphosphine oxides such as Irgacure® 819 (bis(2,4,6-trimethylbenzoyl)phenylphosphine oxide), as described for example in EP-A 7 508, EP-A 57 474, DE-A 196 18 720, EP-A 495 751 or EP-A 615 980, such as 2,4,6-trimethylbenzoyldiphenylphosphine oxide (Lucirin®) TPO), ethyl 2,4,6-trimethylbenzoylphenylphosphinate, benzophenones, hydroxyacetophenones, phenylglyoxylic acid and its derivatives, or mixtures of these photoinitiators. Specific examples that may be mentioned include benzophenone, acetophenone, acetonaphthoquinone, methyl ethyl ketone, valerophenone, hexanophenone, α-phenylbutyrophenone, p-morpholinopropio-phenone, dibenzosuberone, 4-morpholinobenzophenone, 4-morpholinodeoxybenzoin, p-diacetylbenzene, 4-aminobenzophenone, 4′-methoxyacetophenone, β-methylanthraquinone, tert-butylanthraquinone, anthraquinonecarboxylic esters, benzaldehyde, α-tetralone, 9-acetylphenanthrene, 2-acetylphenanthrene, 10-thioxanthenone, 3-acetylphenanthrene, 3-acetylindole, 9-fluorenone, 1-indanone, 1,3,4-triacetylbenzene, thioxanthen-9-one, xanthen-9-one, 2,4-dimethylthioxanthone, 2,4-diethylthioxanthone, 2,4-di-isopropylthioxanthone, 2,4-dichlorothioxanthone, benzoin, benzoin iso-butyl ether, chloroxanthenone, benzoin tetrahydropyranyl ether, benzoin methyl ether, benzoin ethyl ether, benzoin butyl ether, benzoin isopropyl ether, 7-H-benzoin methyl ether, benzo[de]anthracen-7-one, 1-naphthaldehyde, 4,4′-bis(dimethylamino)benzophenone, 4-phenylbenzophenone, 4-chlorobenzophenone, Michler's ketone, 1-acetonaphthone, 2-acetonaphthone, 1-benzoylcyclohexan-1-ol, 2-hydroxy-2,2-dimethylacetophenone, 2,2-dimethoxy-2-phenylacetophenone, 2,2-diethoxy-2-phenylacetophenone, 1,1-dichloroacetophenone, 1-hydroxyacetophenone, acetophenone dimethyl ketal, o-methoxybenzophenone, triphenylphosphine, tri-o-tolylphosphine, benz[a]anthracene-7,12-dione, 2,2-diethoxyacetophenone, benzil ketals, such as benzil dimethyl ketal, 2-methyl-1-[4-(methylthio)phenyl]-2-morpholinopropan-1-one, anthraquinones such as 2-methylanthraquinone, 2-ethylanthraquinone, 2-tert-butylanthraquinone, 1-chloranthraquinone, 2-amylanthraquinone, and 2,3-butanedione.

Also suitable are nonyellowing or low-yellowing photoinitiators of the phenylglyoxalic ester type, as described in DE-A 198 26 712, DE-A 199 13 353 or WO 98/33761.

Among said photoinitiators preference is given to phosphine oxides, α-hydroxy ketones, and benzophenones.

In particular it is also possible to use mixtures of different photoinitiators.

The photoinitiators can be used alone or in combination with a photopolymerization promoter, of the benzoic acid type, amine type or similar type, for example.

Examples of further, typical coatings additives (Q) which can be used include antioxidants, oxidation inhibitors, stabilizers, activators (accelerants), fillers, pigments, dyes, devolatilizers, gloss agents, antistats, flame retardants, thickeners, thixotropic agents, leveling assistants, binders, antifoams, fragrances, surface-active agents, viscosity modifiers, plasticizers, tackifying resins (tackifiers), chelate formers or compatibilizers (see below).

It is also possible to add one or more photochemically and/or thermally activatable initiators, e.g., potassium peroxodisulfate, dibenzoyl peroxide, cyclohexanone peroxide, di-tert-butyl peroxide, azobis-isobutyronitrile, cyclohexanesulfonyl acetyl peroxide, di-iso-propyl percarbonate, tert-butyl peroctoate or benzpinacol, and also, for example, those thermally activatable initiators which have a half-life at 80° C. of more than 100 hours, such as di-t-butyl peroxide, cumene hydroperoxide, dicumyl peroxide, t-butyl perbenzoate, silylated pinacols, which are available commercially from Wacker under the trade name ADDID 600, for example, or hydroxyl-containing amine N-oxides, such as 2,2,6,6-tetramethylpiperidine-N-oxyl, 4-hydroxy-2,2,6,6-tetramethylpiperidine-N-oxyl, etc.

Further examples of suitable initiators are described in “Polymer Handbook”, 2nd ed., Wiley & Sons, New York.

Suitable thickeners, besides free-radically (co)polymerized (co)polymers include customary organic and inorganic thickeners such as hydroxymethylcellulose or bentonite.

As chelate formers it is possible, for example, to use ethylenediamine acetic acid and its salts, and also β-diketones.

Suitable fillers include silicates, examples being silicates obtainable by silicon tetrachloride hydrolysis such as Aerosil® from Degussa, silicious earth, talc, aluminum silicates, magnesium silicates, calcium carbonates, etc.

Suitable stabilizers include typical UV absorbers such as oxanilides, triazines, and benzotriazole (the latter obtainable as Tinuvin® grades from Ciba-Spezialitätenchemie), and benzophenones. These can be used alone or together with suitable free-radical scavengers, examples being sterically hindered amines such as 2,2,6,6-tetramethylpiperidine, 2,6-di-tert-butylpiperidine or derivatives thereof, e.g., bis(2,2,6,6-tetramethyl-4-piperidyl) sebacate. Stabilizers are used normally in amounts of from 0.1 to 5.0% by weight, based on the solid components present in the formulation.

Examples of stabilizers which are additionally suitable include N-oxyls, such as 4-hydroxy-2,2,6,6-tetramethylpiperidine-N-oxyl, 4-oxo-2,2,6,6-tetramethylpiperidine-N-oxyl, 4-acetoxy-2,2,6,6-tetramethylpiperidine-N-oxyl, 2,2,6,6-tetramethylpiperidine-N-oxyl, 4,4′,4″-tris(2,2,6,6-tetramethylpiperidine-N-oxyl) phosphite or 3-oxo-2,2,5,5-tetramethylpyrrolidine-N-oxyl, phenols and naphthols, such as p-aminophenol, p-nitrosophenol, 2-tert-butylphenol, 4-tert-butylphenol, 2,4-di-tert-butylphenol, 2-methyl-4-tert-butylphenol, 4-methyl-2,6-tert-butylphenol (2,6-tert-butyl-p-cresol) or 4-tert-butyl-2,6-dimethylphenol, quinones, such as hydroquinone or hydroquinone monomethyl ether, aromatic amines, such as N,N-diphenylamine, N-nitroso-diphenylamine, phenylenediamines, such as N,N′-dialkyl-para-phenylenediamine, where the alkyl radicals can be identical or different and are each independently composed of 1 to 4 carbon atoms and can be straight-chain or branched, hydroxylamines, such as N,N-diethylhydroxylamine, urea derivatives, such as urea or thiourea, phosphorus compounds, such as triphenylphosphine, triphenyl phosphite or triethyl phosphite, or sulfur compounds, such as diphenyl sulfide or phenothiazine.

The following are examples of typical ranges of content for radiation-curable compositions:
N) 40-100% by weight, preferably 50-90%, more preferably 60-90%, and in particular 60-80% by weight,
O) 0-60% by weight, preferably 5-50%, more preferably 6-40%, and in particular 10-30% by weight,
P) 0-20% by weight, preferably 0.5-15%, more preferably 1-10%, and in particular 2-5% by weight, and
Q) 0-50% by weight, preferably 2-40%, more preferably 3-30%, and in particular 5-20% by weight,
   with the proviso that (N), (O), (P), and (O) together add to 100% by weight.

The radiation-curable urethane (meth)acrylates of the invention are particularly suitable for use as or in compositions which can be cured by high-energy radiation.

These compositions can be used as or in coating materials, e.g., paints, printing inks or adhesives, as printing plates, as moldings or as a casting compound.

Substrates for coating can be, for example, textile, leather, metal, plastic, glass, wood, paper or paperboard, preferably wood or metal, and very preferably wood.

The substrates are coated in accordance with techniques which are conventional and are known to the skilled worker, in which at least one coating composition is applied in the desired thickness to the substrate that is to be coated and any volatile constituents present in the coating composition are removed, with heating where appropriate. This operation can if desired be treated one or more times. Application to the substrate may take place in a known manner, for example, by spraying, troweling, knife coating, brushing, rolling, roller coating, casting, laminating, injection backmolding or coextruding. The coating thickness is generally situated within a range from about 3 to 1000 g/m² and preferably from 10 to 200 g/m².

Further disclosed is a method of coating substrates which comprises applying the coating composition to the substrate and drying it where appropriate in temperatures up to 160° C., curing it with electron beams or UV light under an oxygen-containing atmosphere or, preferably, under inert gas, and subsequently afterdrying it, if desired, at temperatures of up to 160° C.

In addition to or instead of thermal drying NIR radiation may also be used for drying, NIR radiation here referring to electromagnetic radiation in the wavelength range from 760 nm to 2.5 μm, preferably from 900 to 1500 nm.

If two or more coats of the coating composition are applied one atop another, it is possible if desired for thermal and/or NIR drying to take place after each coating operation.

Examples of suitable radiation sources for radiation curing are low-pressure, medium-pressure, and high-pressure mercury lamps and also fluorescent tubes, pulsed lamps, metal halide lamps, electronic flash installations, which allow radiation curing without a photoinitiator, or excimer lamps. Radiation curing takes place by exposure to high-energy radiation, i.e., UV radiation or daylight, preferably light in the wavelength range λ=200 to 700 nm, more preferably λ=200 to 500 nm, and very preferably λ=250 to 400 nm, or by bombardment with high-energy electrons (electron beams; 150 to 300 keV). Examples of radiation sources used include high-pressure mercury vapor lamps, lasers, pulsed lamps (flash lights), halogen lamps or excimer lamps. The radiation dose normally sufficient for crosslinking in the case of UV curing is in the range from 80 to 3000 mJ/cm².

It is of course also possible to use two or more radiation sources for curing, e.g., from two to four.

These sources may also radiate each in different wavelength ranges.

Irradiation can where appropriate also be conducted in the absence of oxygen, e.g., under an inert gas atmosphere. Suitable inert gases include preferably nitrogen, noble gases, carbon dioxide, or combustion gases. Irradiation may also take place with the coating composition covered with transparent media. Examples of transparent media include polymeric films, glass or liquids, e.g., water. Particular preference is given to irradiation in the manner described in DE-A1 199 57 900.

The coating compositions of the invention suitable for use as interior or exterior coatings, i.e., those applications which are exposed to daylight, preferably for buildings or parts of buildings, interior coatings, road markings, and coatings on aircraft and vehicles. The coating compositions of the invention are used in particular as wood-coating materials or in interior wood-coating materials, especially as coating materials for wood flooring.

Figures in ppm and percent used in this text are to be understood as referring to percentages and ppm by weight unless otherwise specified.

### EXAMPLES

Precursor A

In an apparatus with water separator 1035.0 g of Pluriol® A18 TERC (15-fold-ethoxylated trimethylolpropane) from BASF AG were esterified with 165.0 g of acrylic acid and 6.0 g of sulfuric acid in 400.0 g of methylcyclohexane at an internal temperature of 98 to 105° C. Stabilization was carried out with 1.2 g of t-butyl-p-cresol, 1.2 g of triphenyl phosphite, 1.2 g of hypophosphorous acid, 3.6 g of 4-methoxyphenol and 0.036 g of phenothiazine. After a reaction time of 13 hours the solvent was distilled off under reduced pressure (20 mbar) at 112° C. The acid number after distillation was 5 mg of KOH/g. The OH number was 40 mg KOH/g.

Precursor B

In an apparatus with water separator 1039.0 g of Pluriol® A18 TERC (15-fold-ethoxylated tri-methylolpropane) were esterified with 304.0 g of acrylic acid and 6.1 g of sulfuric acid (96%) in 450.0 g of methylcyclohexane at an internal temperature of 98 to 105° C. Stabilization was carried out with 1.2 g of t-butyl-p-cresol, 1.2 g of triphenyl phosphite, 1.2 g of hypophosphorous acid, 4.0 g of 4-methoxyphenol and 0.037 g of phenothiazine. After a reaction time of 10 hours, 40.7 g of aqueous tetra(n-butyl)ammoniumbromide solution (75%) were added and the solvent was distilled off under reduced pressure (20 mbar) at 112° C. The acid number after distillation was 25 mg of KOH/g and the OH number was 40 mg KOH/g. The excess acrylic acid was reacted with 106 g of Epikote®) 828 (bisphenol A diglycidyl ether) from Resolution at a temperature of 105-110° C. for 2 hours. The acid number at the end of the reaction was 2.0 mg KOH/g, the OH number 50 mg KOH/g.

Precursor C

In an apparatus with water separator 1039.0 g of Pluriol® A18 TERC (15-fold-ethoxylated tri-methylolpropane) were esterified with 304.0 g of acrylic acid and 6.1 g of sulfuric acid (96%) in 450.0 g of methylcyclohexane at an internal temperature of 98 to 105° C. Stabilization was carried out with 1.2 g of t-butyl-p-cresol, 1.2 g of triphenyl phosphite, 1.2 g of hypophosphorous acid, 4.0 g of 4-methoxyphenol and 0.037 g of phenothiazine. After a reaction time of 10 hours, 40.7 g of aqueous tetra(n-butyl)ammoniumbromide solution (75%) were added and the solvent was distilled off under reduced pressure (20 mbar) at 112° C. The acid number after distillation was 25 mg of KOH/g and the OH number was 40 mg KOH/g. The excess acrylic acid was reacted with 93.4 g of Basoset®) 162 (trimethylolpropane triglycidyl ether) at a temperature of 105-110° C. for 2 hours. The acid number at the end of the reaction was 1.6 mg KOH/g, the OH number 55 mg KOH/g.

Urethane Acrylate A1, Comparative Example

500 g of precursor A, 58 g of hydroxyethyl acrylate and 0.1 g of dibutyltin laurate were charged to an apparatus and heated to 56° C. Then 87.2 g of 2,4-toluene diisocyanate were added dropwise within the course of 30 minutes at an internal temperature of 55 to 65° C. The reaction was continued at an internal temperature of 65-70° C. for 7 hours until the isocyanate content had fallen to 0.5% by weight. 3.0 g of methanol were added and the reaction was continued at the same temperature for about 3 hours until the isocyanate content had fallen below 0.2% by weight.

Urethane Acrylate B1

467.5 g of precursor B, 30 g of hydroxyethyl acrylate and 0.1 g of dibutyltin laurate were charged to an apparatus and heated to 56° C. Then 58.2 g of 2,4-toluene diisocyanate were added dropwise within the course of 20 minutes at an internal temperature of 55 to 65° C. The reaction was continued at an internal temperature of 65-70° C. for 7 hours until the isocyanate content had fallen to 0.5% by weight. 1.5 g of methanol were added and the reaction was continued at the same temperature for about 3 hours until the isocyanate content had fallen below 0.2% by weight.

Urethane Acrylate B2

467 g of precursor B and 0.5 g of dibutyltin laurate were charged to an apparatus and heated to 60° C. Then 26.7 g of Basonet® HI 100 (hexamethylene isocyanurate) from BASF AG were added dropwise within the course of 10 minutes at an internal temperature of 60 to 65° C. The reaction was continued at an internal temperature of 80-85° C. for 6 hours until the isocyanate content had fallen below 0.2% by weight.

Urethane Acrylate C1

623.3 g of precursor C, 41.0 g of hydroxyethyl acrylate and 0.14 g of dibutyltin laurate were charged to an apparatus and heated to 56° C. Then 87.1 g of 2,4-toluene diisocyanate were added dropwise within the course of 45 minutes at an internal temperature of 48 to 60° C. The reaction was continued at an internal temperature of 65-70° C. for 7 hours until the isocyanate content had fallen to 0.5% by weight. 2.0 g of methanol were added and the reaction was continued at the same temperature for about 3 hours until the isocyanate content had fallen below 0.2% by weight.

Urethane Acrylate C2

500 g of precursor C, 58.0 g of hydroxyethyl acrylate and 0.12 g of dibutyltin laurate were charged to an apparatus and heated to 56° C. Then 87.1 g of 2,4-toluene diisocyanate were added dropwise within the course of 20 minutes at an internal temperature of 50 to 55° C. The reaction was continued at an internal temperature of 65-70° C. for 7 hours until the isocyanate content had fallen to 0.5% by weight. 2.0 g of methanol were added and the reaction was continued at the same temperature for about 3 hours until the isocyanate content had fallen below 0.2% by weight.

Performance Tests

The coating compositions were mixed with 4% by weight of Irgacure 500® photoinitiator from Ciba Spezialitätenchemie, then applied to the respective substrate and exposed under an un-doped high-pressure mercury lamp (output 120 W/cm) with a lamp-to-substrate distance of 12 cm and a belt speed of 10 m/min, to give coatings firm to the fingernail.

The pendulum hardness (PD) was determined in accordance with DIN 53157 and is a measure of the hardness of the coating. The result is reported in the number of swings until the pendulum comes to a standstill (Sg). High values in this test denote high hardness. The films for determining the pendulum hardness were applied to glass using a box-type doctor blade. The film thickness after exposure was 70 μm.

The Erichsen cupping (EC) was determined in accordance with DIN 53156 and is a measure of the flexibility and elasticity. The result is reported in millimeters (mm). High figures denote high flexibility. The films for determining the Erichsen cupping were applied to sheet metal using a spiral-wound wire doctor. The film thickness after exposure was 40 μm.

The viscosity (Visc.) was determined using a cone-and-plate viscometer at 25° C.

To determine the chemical resistance (CH) ethanol, red wine, coffee, blackcurrant juice, mustard, lipstick, disinfectant, ballpoint pen paste, and detergent were applied individually to a cured film 200 μm thick and the discoloration was assessed visually. 0 in this test denotes no discoloration while 5 denotes severe discoloration. The chemical resistance figure given is the mean of the ten individual values.

The iodine color number was determined in accordance with DIN 6162.

The abrasion was determined by the “falling sand” method S 39. For this purpose the coating compositions, containing initiator, were applied to frosted glass plates and exposed so as to give films with a thickness of from 40 to 50 μm.

| | | Iodine | | | | Abrasion |
|---|---|---|---|---|---|---|
| Exam- | Visc. | color | PD | EC | CH 200 μm | fs, S |
| ple | (Pa*s) | number | (Sg) | (mm) | average/10 | 39 (mg) |
| A1 | 6.7 | 4-5 | 55 | 5.8 | 2.45 | tearing |
| B1 | 3.0 | 2-3 | 22 | 5.5 | 2.05 | 5.7 |
| B2 | 1.8 | 2-3 | 96 | 4.2 | 2.15 | 4.7 |
| C1 | 6.4 | 3 | 30 | 4.7 | 2.15 | 6.4 |
| C2 | 6.4 | 2-3 | 28 | 5.5 | 2.15 | 3.8 |

The Inventive Examples B1, B2, C1, and C2 have a much lower iodine color number than Comparative Example A1, and an improved chemical resistance. The increased tough elasticity of the Inventive Examples B1, B2, C1, and C2 as compared with the Comparative Example A1 is manifested in very low levels of abrasion, of less than 10 mg.

1. A radiation-curable urethane (meth)acrylate obtained by a process comprising
a) partly reacting an alkoxylated polyol (A) with (meth)acrylic acid (B) in the presence of at least one esterification catalyst (C) and at least one polymerization inhibitor (D) and also if desired a solvent (E) that forms an azeotrope with water;
b) removing if desired at least some of the water formed in a) from the reaction mixture which can be done during and/or after a);
f) neutralizing if desired the reaction mixture;
h) removing if desired any solvent (E) used by distillation and/or
i) stripping if desired with a gas which is inert under the reaction conditions and removing if desired excess acrylic acid by distilling;
k) reacting the reaction mixture obtained after the last of the above steps with a compound (G) comprising at least two epoxy groups in the presence if desired of a catalyst (H); and
l) reacting the reaction mixture from k) with at least one polyisocyanate (J) and at least one hydroxyalkyl(meth)acrylate (K) and if desired with at least one further compound (M) comprising one or more isocyanate-reactive groups in the presence if desired of a catalyst (L).

2. A process for preparing a radiation-curable urethane (meth)acrylate comprising
a) partly reacting an alkoxylated polyol (A) with (meth)acrylic acid (B) in the presence of at least one esterification catalyst (C) and at least one polymerization inhibitor (D), and also if desired a solvent (E) that forms an azeotrope with water;
b) removing if desired at least some of the water formed in a) from the reaction mixture which can be done during and/or after a);
f) neutralizing if desired the reaction mixture;
h) removing if desired any solvent (E) used by distillation and/or
i) stripping if desired with a gas which is inert under the reaction conditions and removing if desired excess acrylic acid by distilling;
k) reacting the reaction mixture obtained after the last of the above steps with a compound (G) comprising at least two epoxy groups in the presence if desired of a catalyst (H); and
l) reacting the reaction mixture from k) with at least one polyisocyanate (J) and at least one hydroxyalkyl(meth)acrylate (K) and if desired with at least one further compound (M) comprising one or more isocyanate-reactive groups in the presence if desired of a catalyst (L).

3. The radiation-curable urethane (meth)acrylate as claimed in claim 1, wherein the reaction mixture used in k) has an acid number to DIN EN 3682 of up to 200 mg KOH/g and an OH number to DIN 53240 of up to 120 mg KOH/g.

4. The radiation-curable urethane (meth)acrylate as claimed in claim 1, wherein the reaction mixture used in 1) has an OH number to DIN 53240 of up to 250 mg KOH/g.

5. The radiation-curable urethane (meth)acrylate as claimed in claim 1, wherein the polyol (A) is a pentaerythritol, trimethylolethane or trimethylolpropane with from single to 20-fold ethoxylation.

6. The radiation-curable urethane (meth)acrylate as claimed in claim 1, wherein the epoxide compound (G) is bisphenol A diglycidyl ether, 1,4-butanediol diglycidyl ether, trimethylolpropane triglycidyl ether or pentaerythritol tetraglycidyl ether.

7. The radiation-curable urethane (meth)acrylate as claimed in claim 1, wherein the polyisocyanate (J) is 2,4- or 2,6-tolylene diisocyanate or an isomer mixture thereof, hexamethylene diisocyanate, 1,3-bis(isocyanatomethyl)cyclohexane, isophorone diisocyanate or di(isocyanatocyclohexyl)methane.

8. The radiation-curable urethane (meth)acrylate as claimed in claim 1, wherein the hydroxyalkyl (meth)acrylate (K) is 2-hydroxyethyl acrylate or 2-hydroxyethyl methacrylate.

9. A radiation-curable coating composition comprising the radiation-curable urethane (meth)acrylate as claimed in claim 1.

10. An interior wood-coating material comprising the radiation-curable coating composition as claimed in claim 9.
